(19) United States
(12) Patent Application Publication
(10) Pub. No.: US 2019/0359474 A1
(43) Pub. Date: Nov. 28, 2019

(54) TRANSMISSION FLUID REPLACEMENT

(71) Applicant: Mahle Aftermarket Italy S.p.A., Parma (IT)

(72) Inventor: Andrea Cantadori, Parma (IT)

(21) Appl. No.: 16/416,885

(22) Filed: May 20, 2019

(30) Foreign Application Priority Data
May 22, 2018 (IT) 102018000005576

(51) Int. Cl. B67D 7/02; F15B 21/00; B67D 7/62; B67D 7/78; B67D 7/36

(52) U.S. Cl. CPC B67D 7/02; F15B 21/005; B67D 7/36; B67D 7/78; B67D 7/62

(57) ABSTRACT

One embodiment provides an apparatus for replacing transmission fluid of an automatic gear shift, including: a first tube and a second tube, operatively coupled to two different access points of the automatic gear shift; a first tank containing the fresh transmission fluid; a second tank which receives the exhausted transmission fluid; a first three-way electro valve which establishes selective communication between the first tube and the first tank or between the first tube and the second tank; a second three-way electro valve comprising a selective communication between the second tube and the first tank or between the second tube and the second tank; a first pressure gauge and a second pressure gauge operatively coupled to the first tube and to the second tube, respectively, to detect the pressure of the transmission fluid, wherein an oleodynamic manifold comprises a box-like casing housing for the three-way electro valves and the pressure gauges; and a first calibrated throttling is present between the first gauge and the first three-way electro valve and a second calibrated throttling is present between the second gauge and the second three-way electro valve. Other aspects are described and claimed.

### CLAIM FOR PRIORITY

This application claims priority to Italian Application No. 102018000005576, which was filed on May 22, 2018, the contents of which are fully incorporated by reference herein.

### FIELD

The subject matter described herein relates to an apparatus for replacing an exhausted transmission fluid of an automatic gear shift of a motor vehicle with a fresh transmission fluid. In particular, the apparatus may be used in the maintenance of the automatic gear shift for motor vehicles.

### BACKGROUND

As is known, the transmission fluid of the automatic gear shift, generally denoted using the ATF acronym (Automatic Transmission Fluid) is not a simple lubricating fluid, but acts as a transmission fluid of the drive torque.

During the functioning of the gear shift, the ATF tends to heat up, and for this reason a cooling circuit is predisposed comprising at least a pump and a radiator.

As it undergoes wear, the ATF loses viscosity and exposes the automatic gear shift to an increase of wear or faults.

For this reason, it is necessary to periodically replace the ATF, an operation that is carried out in special situations, of which a number of variants exist on the market.

### BRIEF SUMMARY

In summary, one aspect provides an apparatus for replacing an exhausted transmission fluid of an automatic gear shift of a motor vehicle with a fresh transmission fluid, comprising: a first tube and a second tube, operatively coupled to two different access points of the automatic gear shift; a first tank containing the fresh transmission fluid; a second tank which receives the exhausted transmission fluid; a first three-way electro valve which establishes selective communication between the first tube and the first tank or between the first tube and the second tank; a second three-way electro valve comprising a selective communication between the second tube and the first tank or between the second tube and the second tank; a first pressure gauge and a second pressure gauge operatively coupled to the first tube and to the second tube, respectively, to detect the pressure of the transmission fluid, wherein an oleodynamic manifold comprises a box-like casing housing for the three-way electro valves and the pressure gauges; and a first calibrated throttling is present between the first gauge and the first three-way electro valve and a second calibrated throttling is present between the second gauge and the second three-way electro valve.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates the oleodynamic diagram of an apparatus for replacing an exhausted transmission fluid of an automatic gear shift of a motor vehicle with a fresh transmission fluid, according to the prior art;

FIG. 2 illustrates a simplified oleodynamic diagram of an apparatus for replacing an exhausted transmission fluid of an automatic gear shift of a motor vehicle with a fresh transmission fluid, according to an embodiment;

FIG. 3 schematically illustrates the connection of the apparatus of FIG. 2 with the cooling circuit of a gear shift.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

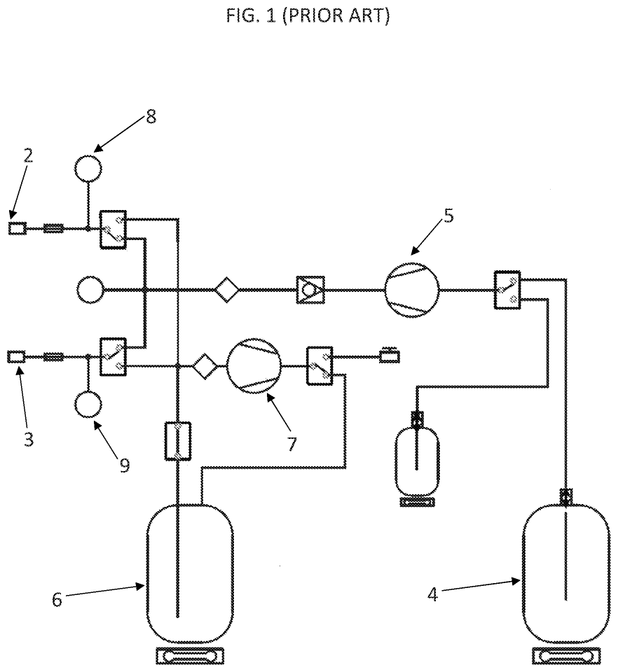

FIG. 1 illustrates a replacement station or apparatus of the ATF of known type developed by the Applicant, in which the following in particular are noted: two tubes 2, 3 intended to be connected in series to the cooling circuit of the ATF; a tank 4 containing the new ATF; a discharge tank 6 of the exhausted ATF; a first pump 5 for collecting the fresh ATF from the corresponding tank 4; a second pump 7 upstream of the discharge tank 6; a valve system configured to establish various paths of the ATF as a function of the specific operating step of the station.

When the replacement of the ATF is necessary, the ATF cooling circuit is interrupted to enable connection in series of the station of FIG. 1.

The interruption of the cooling circuit can take place in different ways according the availability of specific oleodynamic connections, the operator's capacities and the possibility of access to the gear shift structure.

Using the known solution of FIG. 1, the operator need not consider the flow direction of the ATF in order to carry out the connection. In fact, the pressure gauges 8, 9 detect the ATF pressure and enable automatically establishing the flow direction.

Therefore each tube can function as delivery or return: it is a control unit that controls the valve system in such a way as to establish the ATF path as a function of the detected flow direction.

Apart from the structural variants, at least two functioning steps of the station are distinguished: a recirculation step and a flushing step.

The recirculation step takes place as soon as the station is connected to the cooling circuit of the ATF. During this step, the vehicle is still in motion and the ATF continues to circulate in the cooling circuit and in the station, entering by one tube and exiting from the other.

To carry out the replacement of the ATF the flushing step is used, which represents a dynamic replacement of the ATF, i.e. with the engine functioning. In particular, the flow of the exhausted ATF (to be replaced) is deviated towards the discharge tank 6, while the first pump 5 collects the fresh ATF from the other tank 4 and sends it towards the gear shift.

The above-described solution is however not free from limits.

As is known, an ATF replacement service might be accompanied, in some circumstances, by the replacement of the filter of the gear shift with the relative seal; this operation necessarily includes the demounting of some parts of the gear shift.

The solution of FIG. 1, while automatically detecting the flow direction of the ATF, does not enable the operator to establish whether it is necessary also to replace the filter. At present, the decision to replace the filter is taken by the operator beforehand, on an empirical basis, for example when a specific kilometre-based threshold for each vehicle has been exceeded.

In this context, the technical task underpinning an embodiment is to disclose an apparatus for replacing an exhausted transmission fluid of an automatic gear shift of a motor vehicle with a fresh transmission fluid that obviates the drawbacks of the prior art cited in the foregoing.

In particular, an aim of an embodiment is to disclose an apparatus for replacing an exhausted transmission fluid of an automatic gear shift of a motor vehicle with a fresh transmission fluid, which enables establishing whether it is necessary also to replace the filter of the gear shift due to clogging thereof.

The specified technical task and the specified aims are substantially attained by an apparatus for replacing an exhausted transmission fluid of an automatic gear shift of a motor vehicle with a fresh transmission fluid, comprising: a first tube and a second tube, respectively connectable to two different access points of the automatic gear shift; a first tank containing the fresh transmission fluid; a second tank configured to receive the exhausted transmission fluid; a first three-way electro valve configured to establish a selective communication between the first tube and the first tank or between the first tube and the second tank;-a second three-way electro valve configured to establish a selective communication between the second tube and the first tank or between the first tube and the second tank;-a first pressure gauge and a second pressure gauge which are operatively active respectively on the first tube and on the second tube so as to detect the pressure of the transmission fluid, characterised in that it comprises an oleodynamic manifold in turn comprising a box-like casing housing the three-way electro valves and the pressure gauges and in that a first calibrated throttling is present between the first pressure gauge and the first three-way electro valve and a second calibrated throttling is present between the second pressure gauge and the second three-way electro valve.

The apparatus preferably comprises a temperature sensor housed in the box-like casing of the oleodynamic manifold. The temperature sensor is preferably interposed between the first three-way electro valve and the second three-way electro valve. The apparatus preferably comprises a driving unit configured to drive said first and said second three-way electro valves in a complementary way so that when the first tube communicates with the first tank the second tube communicates with the second tank, and when the first tube communicates with the second tank the second tube communicates with the first tank. The apparatus preferably comprises a first pump configured to suck the fresh transmission fluid from the first tank. The apparatus preferably also comprises a second pump configured to convey the exhausted transmission fluid to the second tank. The apparatus preferably comprises two visual level indicators, respectively arranged on the first tube and on the second tube. The apparatus preferably also comprises first weighing means operatively active on the first tank to detect the weight of the fresh transmission fluid contained therein; second weighing means operatively active on said second tank to detect the weight of the exhausted transmission fluid contained therein.

Further characteristics and advantages will become more apparent from the indicative and thus non-limiting description of a preferred, but not exclusive, embodiment of an apparatus for replacing an exhausted transmission fluid of an automatic gear shift of a motor vehicle with a fresh transmission fluid, as illustrated in the appended drawings.

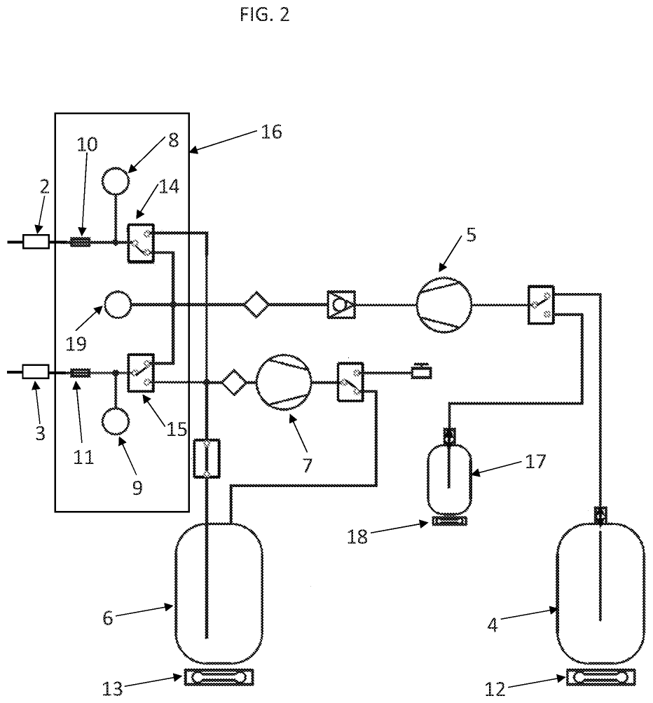

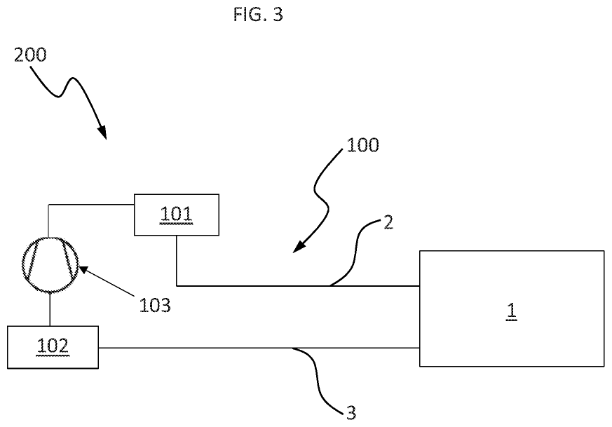

With reference to FIGS. 2 and 3, reference numeral 1 denotes an apparatus (or station) for replacing an exhausted transmission fluid of an automatic gear shift 200 of a motor vehicle with a fresh transmission fluid.

For the sake of brevity, in the following the above-mentioned transmission fluid shall be indicated by the acronym ATF, well known in the specific sector.

The automatic gear shift 200 is external to the apparatus 1.

In particular, the automatic gear shift 200 comprises a cooling circuit 100 of the ATF. The automatic gear shift 200 also comprises a radiator 101, a sump 102 containing the ATF and a pump 103. These elements are all external to the apparatus 1 disclosed herein. The introduction thereof in this description is uniquely linked to reasons of clarity of illustration.

The apparatus 1 comprises a first tube 2 and a second tube 3, respectively connectable to two different access points of the automatic gear shift 200. For example, in the embodiment described and illustrated herein, the two different points of access consist of two points of interruption of the cooling circuit 100. For example, in FIG. 3 it can be observed that one of the tubes 2 is connected to the radiator 101 of the automatic gear shift 200, while the other tube 3 is connected to the ATF sump 102.

The fresh ATF is contained in a first tank 4, while the exhausted ATF is contained in a second tank 6.

The apparatus 1 comprises two three-way electro valves 14, 15, in particular: a first three-way electro valve 14 configured to establish a selective communication between the first tube 2 and the first tank 4 or between the first tube 2 and the second tank 6; a second three-way electro valve 15 configured to establish a selective communication between the second tube 3 and the first tank 4 or between the second tube 3 and the second tank 6.

A first pressure gauge 8 is inserted on the first tube 2 and a second pressure gauge 9 is inserted on the second tube 3 so as to detect the pressure of the ATF.

Originally the two three-way electro valves 14, 15 and the two pressure gauges 8, 9 are housed in a box-like casing of an oleodynamic manifold 16. The box-like casing also houses two throttles or calibrated holes 112, 113, that is, a first calibrated throttling 112 between the first pressure gauge 8 and the first three-way electro valve 14 and a second calibrated throttling 113 between the second pressure gauge 9 and the second three-way electro valve 15. A temperature sensor 19 is also preferably housed inside the box-like casing. In particular, the temperature sensor 19 is interposed between the two three-way electro valves 14, 15.

A driving unit (not illustrated) is included that is configured to drive the two three-way electro valves 14, 15 in a complementary way: when the first tube 2 communicates with the first tank 4, the second tube 3 communicates with the second tank 6; when the first tube 2 communicates with the second tank 6, the second tube 3 communicates with the first tank 4.

Up to now, and generically, two tubes 2, 3 have been introduced, connectable to the cooling circuit 100.

In this context, by delivery tube is meant the tube supplying the fresh ATF to the cooling circuit 100 during a flushing step, while by return tube is meant the tube receiving the exhausted ATF during the same flushing step.

In the embodiment described and illustrated in the present description, each of the tubes 2, 3 can function both as a delivery tube and as a return tube. The choice is not made by the operator, but is determined by automatically detecting the flow direction of the ATF (a method already known).

For the sake of simplicity, the first tube 2 represents the delivery tube, while the second tube 3 represents the return tube.

A first pump 5 is preferably interposed between the first tank 4 and the delivery tube 2, which is configured to force the flow of the fresh ATF from the first tank 4 to the delivery tube 2.

The exhausted ATF, coming from the return tube 3, is collected in a second tank 6.

A second pump 7 is preferably interposed between the return tube 3 and the second tank 6, which is configured to force the flow of the exhausted ATF from the return tube 3 to the second tank 6. Each of the two pumps 5, 7 is activated by a corresponding motor (not illustrated).

In FIG. 2 two separate lines or paths of the ATF can be identified: a delivery line which goes from the first tank 4 to the delivery tube 2 passing through the first pump 5 in which the fresh ATF flows; a return line which goes from the return tube 3 to the second tank 6, in which the exhausted ATF flows.

A corresponding visual level indicator 10, 11 is preferably inserted on the delivery line and on the return line. For example, as a visual level indicator a portion of tube can be used, made of a transparent material, such as glass or plastic or an acrylic material.

In the embodiment described and illustrated herein, the detecting of the quantity of ATF contained in the two tanks 4, 6 is carried out by weighing means 12, 13. In particular, first weighing means 12 are operatively active on the first tank 4, which preferably consist of an electronic scale. Second weighing means 13 are operatively active on the second tank 6, which also preferably consist of an electronic scale.

In an alternative embodiment (not illustrated), the detecting of the quantity of ATF contained in the two tanks 4, 6 is carried out using optical sensors.

The apparatus 1 further comprises means (not illustrated) to fill or top up the two tanks 4, 6, for example funnels or connecting tubes between the funnels and tanks 4, 6. The apparatus 1 preferably further comprises a third tank 17 containing a washing fluid and corresponding third weighing means 18, for example consisting of an electronic scale. The apparatus 1 further comprises a system of valves, filters and taps (of known type) to establish the ATF flows as a function of the various operating steps, among which the already-mentioned recirculation and flushing steps.

The driving unit of the three-way electro valve 14, 15 is part of a control unit configured to drive the entire system of valves and taps in response (at least in part) to the pressure values of the ATF detected by the pressure gauges 8, 9, to the temperature value detected by the temperature sensor 19 and to the weights detected by the scales 12, 13, 18.

In particular, during the flushing step, the control unit 16 receives in inlet the weights detected by the scales 12, 13 operating on the first and second tank 4, 6 and controls the system of valves and taps in such a way as to guarantee a substantial equilibrium between the quantity of exhausted ATF which is removed from the cooling circuit 100 and the quantity of fresh ATF which is injected into the cooling circuit 100.

The apparatus 1 preferably comprises a frame (not illustrated) housing the various components. The frame is preferably provided with wheels to enable the user to easily displace the apparatus 1. From the description the characteristics of the apparatus for replacing an exhausted transmission fluid of an automatic gear shift of a motor vehicle with a fresh transmission fluid clearly emerge, as do the advantages thereof

In particular, the single manifold comprising the two pressure gauges, the calibrated throttling and the three-way electro valves enables detection not only of the direction but also of the entity of the ATF flow during the recirculation step. This detection enables an understanding of whether the ATF is clogged by dirt accumulated in the filter (for example sludge, filings from the gears, etc.), signaling to the operator that this is time to carry out the replacement of the filter.

The use of a single manifold enables a minimizing of the length of the portion of circuit, guaranteeing that the two measurement points are at the same temperature. In fact, the pressure drop depends on the density of the ATF, which in turn depends on the temperature. For this precise reason, it has been chosen to position the temperature sensor centrally between the two electro valves (and pressure gauges), thus guaranteeing greater accuracy in the establishing of whether it is necessary or not to replace the filter.

Example embodiments are described herein with reference to the figures, which illustrate example methods, devices and program products according to various example embodiments. It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An apparatus for replacing an exhausted transmission fluid of an automatic gear shift of a motor vehicle with a fresh transmission fluid, comprising:
a first tube and a second tube, operatively coupled to two different access points of the automatic gear shift;
a first tank containing the fresh transmission fluid;
a second tank which receives the exhausted transmission fluid;
a first three-way electro valve which establishes selective communication between the first tube and the first tank or between the first tube and the second tank;
a second three-way electro valve comprising a selective communication between the second tube and the first tank or between the second tube and the second tank;
a first pressure gauge and a second pressure gauge operatively coupled to the first tube and to the second tube, respectively, to detect the pressure of the transmission fluid, wherein an oleodynamic manifold comprises a box-like casing housing for the three-way electro valves and the pressure gauges; and
a first calibrated throttling is present between the first gauge and the first three-way electro valve and a second calibrated throttling is present between the second gauge and the second three-way electro valve.

2. The apparatus of claim 1, further comprising a temperature sensor housed in the box-like casing of the oleodynamic manifold.

3. The apparatus of claim 2, wherein the temperature sensor is interposed between the first three-way electro valve and the second three-way electro valve.

4. The apparatus of claim 1, further comprising a driving unit which drives the first and the second three-way electro valves in a complementary way so that when the first tube communicates with the first tank the second tube communicates with the second tank, and when the first tube communicates with the second tank the second tube communicates with the first tank.

5. The apparatus of claim 1, further comprising a first pump which pumps the fresh transmission fluid from the first tank.

6. The apparatus of claim 1, further comprising a second pump which conveys the exhausted transmission fluid to the second tank.

7. The apparatus of claim 1, further comprising two visual level indicators, respectively arranged on the first tube and on the second tube.

8. The apparatus of claim 1, further comprising:
a first weighing means operatively active on the first tank which detects the weight of the fresh transmission fluid contained therein;
a second weighing means operatively active on the second tank which detects the weight of the exhausted transmission fluid contained therein.
